(19) United States
(12) Patent Application Publication
(10) Pub. No.: US 2007/0050352 A1
(43) Pub. Date: Mar. 1, 2007

(54) SYSTEM AND METHOD FOR PROVIDING AUTOCOMPLETE QUERY USING AUTOMATIC QUERY TRANSFORM

(75) Inventor: Tae-Il Kim, Kyunggi-do (KR)

Correspondence Address: BLACKWELL SANDERS PEPER MARTIN LLP, 720 OLIVE STREET, SUITE 2400, ST. LOUIS, MO, 63101, US

(73) Assignee: NHN CORPORATION, Kyunggi-do (KR)

(21) Appl. No.: 11/467,982

(22) Filed: Aug. 29, 2006

(30) Foreign Application Priority Data
Aug. 30, 2005 (KR) 10-2005-0080259

(51) Int. Cl. G06F 17/30

(52) U.S. Cl. 707/4

(57) ABSTRACT

A method and system for providing an auto complete query is provided, and more particularly, a method and system for providing an auto complete query, which can classify a query log according to at least one index, record the classified query log for each of the at least one index, extract a corresponding query according to partial or full search query from the user and a setting mode which are received from a user's web browser, and provide the user with the extracted query, and also can provide an appropriate recommendation query, based on when a user enters a query by auto-converting the partial or full search query into an appropriate query when the partial or fall search query is inappropriate.

### CROSS-REFERENCE TO RELATED APPLICATION

This application claims the benefit of Korean Patent Application No. 10-2005-0080259, filed on Aug. 30, 2005, in the Korean Intellectual Property Office, the disclosure of which is incorporated herein by reference.

### BACKGROUND OF THE INVENTION

1. Field of the Invention

The present invention relates to a method and system for providing an auto-completion function, and more particularly, to a method and system for auto-completing a partial or full search query entered by a user by anticipating the user's request, which can classify a query log according to at least one index, record the classified query log for each of the at least one index, extract a corresponding query according to the partial or full search query entered by the user and a setting mode which are received from a user's web browser, and provide the user with a suggested, predicted, or alternative query.

2. Description of the Related Art

Once the user signals that all of the search terms are entered, the query is sent to the search engine. Once the query is received, the search engine processes the search query, searches for documents responsive to the search query, and returns search results, for example, web sites including the query, articles including the query, and images including the query as a file name.

Search services are currently being improved to increase users' conveniences. Accordingly, when a user inputs an appropriate query, the search service must provide satisfactory search results. Also, even when the user inputs an inappropriate query, the search service must provide appropriate search results which can satisfy the user. Specifically, as users of search service are being expanded and also users who do not have enough background knowledge about appropriate queries increase, it is required to guide the users to make an appropriate query.

Also, when a user enters a mistyped character into a search window, how to handle the mistyped character and provide the user with satisfactory search results becomes an issue. The mistyped character may be generated, for example, 1) when a pronunciation is similar such as “Emma Watts on” and “Emma Watson”, orthographies of borrowed words are confused, 2) when visually similar characters are confused, such as “the Uruguay Round” and “Anna's Diary”, 3) when a user inputs a special character via a keyboard, such as “]”, and “!”, and 4) when using alphabetical characters for Hangul. Accordingly, a proper solution for the inputted mistyped character is required.

However, in the conventional search service, only passive solutions are utilized, such as 1) a method of converting a query into another query and providing search results using a predetennined converting list, when a user inputs the query into a search window for a search request and the query is included in the converting list, and 2) a method of outputting search results even when the user inputs a wrong query, and recommending at least one other query to the user.

Specifically, the method 1) may output search results with respect to a query that the user does not substantially desire. Also, the method 2) initially outputs search results with respect to the wrongfully inputted query and subsequently recommends another query to the user.

Accordingly, the user is required to select the other query and request the search again.

Also, according to the methods 1) and 2), search service providers must repeatedly perform predetermined operations, such as preparing any possible mistyped characters, and adding the same to a converting list or a recommendation list with a large number of human resources. Accordingly, some delays may occur in other important fields such as site registration or creating and searching of contents, which may also deteriorate productivity.

Thus, there has been a need for a new type of technology which can prevent a mistyped character before a user transmits a query, and also can classify a query log for each index based on various standards, and automatically complete the query the user is currently entering, according to a partial or full search query entered by the user and a setting mode which are received from the user's web browser, so as to significantly improve a mistyped character correction function of a search service is required.

### BRIEF SUMMARY OF INVENTION

The present invention provides a method and system for providing an auto complete query, which can provide a user with an appropriate or alternative query in real time when the user enters a query. Before the user finishes entering the search query, the search system identifies and sends a partial or full search query entered by the user to the search system.

The present invention also provides a method and system for providing an auto complete query, which prevents a user from inputting a mistyped character and educate the user on how to create an appropriate query.

The present invention also provides a method and system for providing an auto complete query, which can convert a partial or full query entered by the user into an appropriate or alternative query and provide a user with an auto complete query corresponding to the appropriate query in real time, even when the user enters a query different from their intent due to a mis-configured keyboard, such as when a keyboard is set to English, but the user enters the query according to a keyboard set to a different language, such as a Hangul (Korean), and when a keyboard is set to the different language, but the user enters the query according to an English keyboard.

The present invention also provides a method and system for providing an auto complete query, which enables a user to select a desired query from the auto complete query list while the user is inputting a query, and thereby, easily complete the query by providing the user with an auto complete query list where a query log is classified for each index and the query that the user is currently inputting can be automatically completed according to a partial or full search query entered by a user and a setting mode which are received from the user's web browser.

The present invention also provides a method and system for providing an auto complete query, which can classify a query log according to a consonant/vowel unit to be appropriate for a particular language, which can be classified into a consonant/vowel unit, such as Hangul, and can extract an auto complete query corresponding to the classified query log, and provide a user with the extracted auto complete query, when the user enters a query corresponding to the consonant unit/vowel unit.

The present invention also provides a method and system for providing an auto complete query, which can provide a query autocompletion capability using both a prefix and a suffix.

Here, the prefix is added to the beginning of a word and the suffix is added to the end of the word.

The present invention also provides a method and system for providing an auto complete query, which can significantly reduce temporal and economic losses in preparing a converting list or a recommendation list for correcting a mistyped character by constructing a system that can effectively classify a query log received from a user for each index according to various standards, extract an auto complete query with respect to partial or full search query entered by a user in real time, and provide the extracted auto complete query.

The present invention also provides a method and system for providing an auto complete query, which can embody a query autocompletion to thereby reduce a user's query input time, and assist the user, particularly, the user who is poor at using a keyboard, when inputting a query.

The present invention also provides a method and system for providing an auto complete query, which can supplement a user's memory when the user remembers only a part of a query.

The present invention also provides a method and system for providing an auto complete query, which can satisfy a user who desires to understand other users 'query tendencies with respect to a corresponding input query.

According to an aspect of the present invention, there is provided a system for providing an auto complete query, the system including: a log database for maintaining a query log; a log indexer module for classifying the query log maintained in the log database; a query index database for divides and storing the classified query log; a web server for receiving partial or full search query entered by a user from a user's web browser, transferring the received partial or full search query to a predetermined query autocompletion server, receiving at least one suggested auto complete query from the query autocompletion server, and transmitting the received at least one suggested autocomplete query to the web browser; and the query autocompletion server for receiving the partial or full search query from the web server, determining whether the partial or full search query is appropriate is appropriate according to a predetermined, and when the partial or full search query is inappropriate according to the standard, automatically converting the partial or full search query into an appropriate query, extracting at least one suggested auto complete query associated with the appropriate query from the query index database, and transmitting the extracted at least one suggested auto complete query to the web server.

According to another aspect of the present invention, there is provided a method of providing an auto complete query, the method including: maintaining a query log in a log database; classifying the query log maintained in the log database in a log indexer module; storing the classified query log in a query index database; receiving partial or full search query entered by the user from a user's web browser and transferring the received partial or full search query to a predetermined query autocompletion server, using a web server; receiving the partial or full search query from the web server, detennining whether the partial or full search query is appropriate according to a predetermined standard, and when the partial or full search query is inappropriate according to the standard, automatically converting the partial or full search query into an appropriate query, extracting at least one suggested auto complete query associated with the appropriate query from the query index database, and transmitting the extracted at least one suggested auto complete query to the web server, using the query autocompletion server; and receiving at least one suggested auto complete query from the query autoco/inpletion server and transmitting the received at least one suggested auto complete query to the web browser, using the web server.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a diagram illustrating a network connection of a system for providing an autocomplete query according to an exemplary embodiment of the present invention;

FIG. 2 is a block diagram illustrating a configuration of a system for providing an autocomplete query according to an exemplary embodiment of the present invention;

FIG. 3 is a flowchart illustrating a method of providing an autocomplete query according to an exemplary embodiment of the present invention;

FIG. 4 is a diagram illustrating an example of a query index database recording a query log which is divided using a consonant/vowel unit index according to an exemplary embodiment of the present invention;

FIG. 5 is a diagram illustrating an example of a query index database recording a query log which is divided using a syllable unit index according to an exemplary embodiment of the present invention;

FIG. 6 is a diagram illustrating an example of a query index database recording a query log which is divided using a suffix index according to an exemplary embodiment of the present invention;

FIG. 7 is a diagram illustrating an example of an auto complete query list which is provided to a user, when the user enters a query corresponding to a consonant/vowel unit according to an exemplary embodiment of the present invention;

FIG. 8 is a diagram illustrating an example of an autocomplete query list which is provided to a user, when a consonant/vowel unit index is selected as a setting mode according to an exemplary embodiment of the present invention;

FIG. 9 is a diagram illustrating an example of an autocomplete query list which is provided to a user, when a syllable unit index is selected as a setting mode according to an exemplary embodiment of the present invention;

FIG. 10 is a diagram illustrating an example of an autocomplete query list which is provided to a user, when a suffix index is selected as a setting mode according to an exemplary embodiment of the present invention; and

FIG. 11 is a diagram illustrating an autocomplete query list which is overlapped on a search webpage according to an exemplary embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

As used in this application, the terms “component,” “module” and “system” are intended to refer to a computer-related entity, either hardware, a combination of hardware and software, software, or software in execution. For example, a module or a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a module. One or more modules or components can reside within a process and/or thread of execution, and a module or component can be localized on one computer and/or distributed between two or more computers.

As used herein, the terms “desktop,” “PC,” “local computer,” and the like, refer to computers on which systems (and methods) according to the invention operate. In the illustrated embodiments, these are personal computers, such as portable computers and desktop computers; however, in other embodiments, they may be other types of computing devices (e.g., workstations, mainframes, personal digital assistants or PDAs, music or MP3 players, and the like).

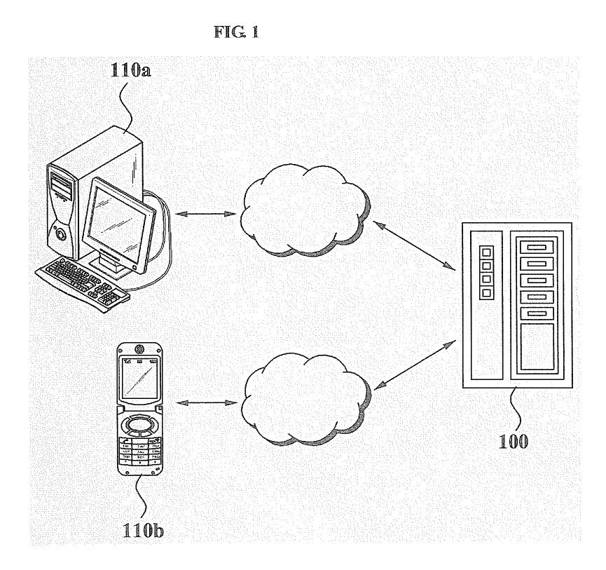

FIG. 1 is a diagram illustrating a network connection of a system for providing an auto complete query according to an exemplary embodiment of the present invention.

An autocomplete query providing system 100 maintains a query log in a predetermined log database, classifies the query log maintained in the log database according to any one of a consonant/vowel unit, a syllable unit, and a suffix in a log indexer module, and classifies and stores the classified query log for each of the any one of consonant/vowel unit indexes, syllable unit indexes, and suffix indexes in a predetermined query index database.

A user accesses a web server of the autocomplete query providing system 100 via a wired/wireless network using a user terminal ll0a or 110b, and inputs a query. In this case, the web server receives input information, which includes a partial or full search query entered by the user and a setting mode from the user's web browser, and transfers the received input information to a query autocompletion server of the autocomplete query providing system 100. Also, the query autocompletion server receives the input information from the web server, extracts at least one suggested autocomplete query associated with the input infonnation, and transmits the extracted at least one suggested autocomplete query to the web server. Also, the auto complete query providing system 100 may determine whether the partial or full search query included in the input information is appropriate. As a result of the determination, when it is inappropriate, the autocomplete query providing system 100 may automatically convert the partial or full search query into an appropriate query, extract at least one suggested auto complete query associated with the appropriate query from the query index database, and transmit the extracted at least one suggested autocomplete query to the web server. Accordingly, the web server receives the at least one suggested autocomplete query from the query autocompletion server, transmits the received at least one suggested autocomplete query to the web browser so that the user can select the user's desired autocomplete query while inputting a query, and thereby, easily complete the query before the user signals that a complete query is entered.

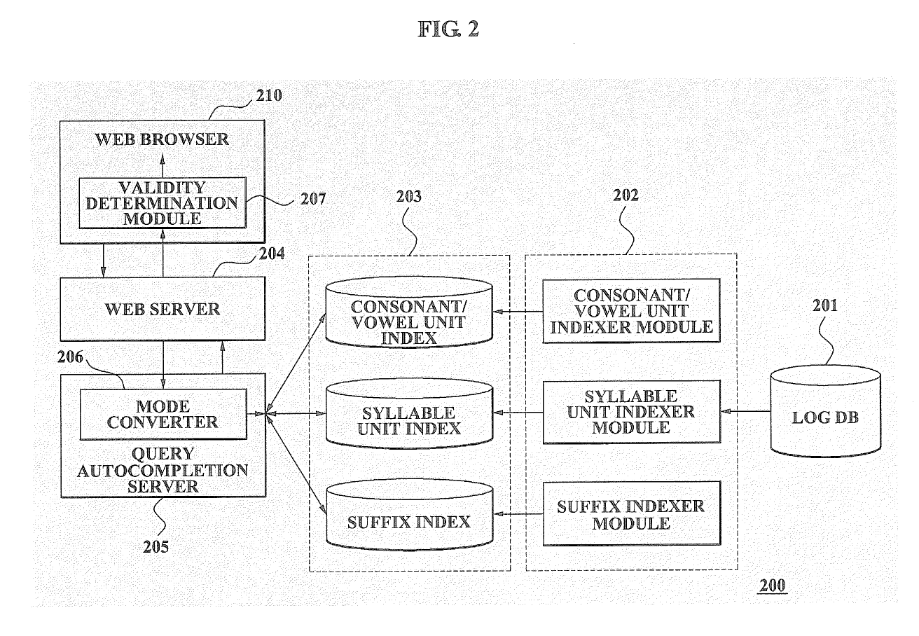

FIG. 2 is a block diagram illustrating a configuration of a system for providing an auto complete query according to an exemplary embodiment of the present invention.

An autocomplete query providing system 200 according to the present exemplary embodiment may include a log database 201 for maintaining a query log; a log indexer module 202 for classifying the query log maintained in the log database 201; a query index database 203 for storing the classified query log; a web server 204 for receiving a partial or full search query entered by the user from a user's web browser 210, transferring the received partial or full search query to a predetennined query autocompletion server 205, receiving at least one suggested auto complete query from the query autocompletion server 205, and transmitting the received at least one suggested autocomplete query to the web browser 210; and the query autocompletion server 205 for receiving the partial or full search query from the web server 204, determining whether the partial or full search query is appropriate according to a predetermined standard, and when the partial or full search query is inappropriate according to the predetermined standard, automatically converting the partial or full search query into an appropriate query, extracting at least one suggested autocomplete query associated with the appropriate query from the query index database 203, and transmitting the extracted at least one suggested autocomplete query to the web server 204.

Also, according to another embodiment of the present invention, the setting mode includes selection information about at least one of a consonant/vowel unit index, a syllable unit index, and a suffix index. Also, the query autocompletion server 205 may include a mode converter 206 for detennining whether the setting mode with respect to the partial or full search query is appropriate according to a predetermined standard, and when the setting mode is inappropriate, automatically converting the setting mode into another mode. In this case, the query autocompletion server 205 may extract at least one suggested autocomplete query from the query log corresponding to the automatically converted mode from the query index database 203.

Also, according to still another embodiment of the present invention, the web server 204 transmits the at least one suggested autocomplete query and the partial or full search query to the web browser 210. The autocomplete query providing system 200 may further include a validity determination module 207. The validity determination module 207 determines whether the partial or full search query is identical to a current input query in the web browser 210, and when the partial or full search query is identical to the current input query, outputs the at least one suggested autocomplete query.

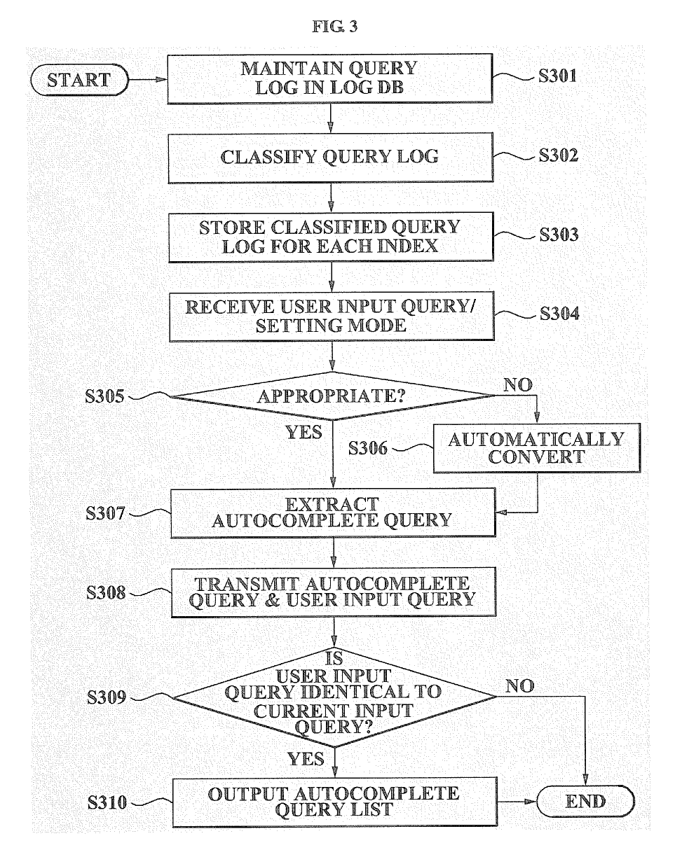

FIG. 3 is a flowchart illustrating a method of providing an autocomplete query according to an exemplary embodiment of the present invention. The method of providing an auto complete query according to the present exemplary embodiment may be performed by the auto complete query providing system 200 as shown in FIG. 2.

In operation S301, the autocomplete query providing system 200 maintains a query log in the log database 201.

The query log may be a query dataset that users inputted into a predetermined search web site of the web server 204 of the autocomplete query providing system 200. Also, the query log may include search frequency for each query. In this instance, the search frequency may be, for example, a type of statistical information which is generated by analyzing how many times a particular query has been inputted during a predetermined period.

In operation S302, the log indexer module 202 of the autocomplete query providing system 200 classifies the query log maintained in the log database 201 according to any one of a consonant/vowel unit, a syllable unit, and a suffix. In this case, the log indexer module 202 may include a consonant/vowel unit indexer component, a syllable unit indexer component, and a suffix indexer component.

In the present invention, “classifying” the query log may include indexing the query log using at least one of a consonant/vowel unit, a syllable unit, a suffix, and the like.

Accordingly, a single query may be classified using only one method, and also classified as all of the consonant/vowel unit, the syllable unit, and the suffix according to a method where the query is indexed. As an example, a query log [symbol] (a “donkey” in English) may be indexed into [symbol] , [symbol] , [symbol] , [symbol] , [symbol] , [symbol] , [symbol] , and [symbol] according to the consonant/vowel unit. Also, the query log may be indexed into [symbol] , [symbol] , and [symbol] according to the syllable unit, and may also be indexed into [symbol] , [symbol] , and [symbol] according to the suffix.

The greatest distinguishing characteristic of Hangul, which is different from other foreign characters such as Chinese characters, is that Hangul consists of consonant units and vowel units. Specifically, Hangul includes basic consonants and vowels which include 19 initial sounds, 21 intermediate sounds, and 28 final sounds, and regularly combines the basic consonants and vowels to generate a word. Depending upon the character of Hangul, the consonant/vowel indexer component of the log indexer module 202 functions to classify the query log maintained in the log database 201 according to the consonant/vowel unit.

The term “consonant/vowel unit” used throughout the present specification includes a general meaning of consonants and vowels, such as the initial sounds, the intermediate sounds, and the final sounds, and also includes all the characters and words which are generated by combining the initial sound and the final sound. As an example, [symbol] may be divided into two consonant/vowel units, such as [symbol] and [symbol] . Also, [symbol] itself may correspond to a single consonant/vowel unit.

Also, in the present invention, the tenn “consonant/vowel unit” includes a concept of a “minimal input unit of an input terminal”. As an example, [symbol] and “k” must be inputted to generate the single vowel [symbol] in a Hangul dual mode keyboard. In the case of a simple consonant/vowel unit, a word [symbol] may be indexed into [symbol] , [symbol] , [symbol] and [symbol] . However, in the present invention, as described above, the “consonant/vowel unit” includes the concept of the “minimal input unit of the input terminal”. Accordingly, in the case of a Hangul dual mode keyboard, the word [symbol] may be indexed into [symbol] , [symbol] , [symbol] , [symbol] and [symbol] . Also, when the input tenninal is changed into another terminal following a different input method, indexes of the minimal input unit may be changed.

Also, the syllable unit indexer component of the log indexer module 202 functions to classify a query log maintained in the log database 201 according to the syllable unit, and the suffix indexer component of the log indexer module 202 functions to classify the query log maintained in the log database 201 according to the suffix.

The suffix is a kind of affix, and is added to the end of a word to add a meaning, and thereby generally generates another word. Also, the suffix may not be used alone, and is combined to the root of a word to add various meanings. As an example, suffixes, which are added to substantives, may include [symbol] , which designates a honorific title, [symbol] , [symbol] etc. which designates an operating subject, [symbol] , which designates plural, and [symbol] , [symbol] , [symbol] and the like.

However, in the present invention, the term “suffix” includes the same usage as in the English language, and also designates all the words and characters which can be added to a tail of a word.

In operation S303, the autocomplete query providing system 200 stores the classified query log for each of the consonant/vowel unit indexes, the syllable unit indexes, and the suffix indexes in the query index database 203. For this, the query index database 203 may record the query log for each of the consonant/vowel unit index, the syllable unit index, and the suffix index, as shown in FIG. 2.

In the present invention, “dividing” the query log may include indexing the query log using at least one of the consonant/vowel unit, the syllable unit, the suffix, and the like, and has the same meaning as “classifying” described above.

Accordingly, a single query may be divided using only a single index, and also may be divided using all of the consonant/vowel unit, the syllable unit, and the suffix according to a method where the query is indexed, and recorded in the query index database 203. As an example, a query log [symbol] , may be recorded in the consonant/vowel unit index, such as [symbol] and also recorded in the syllable unit index, such as [symbol] . Also, the query log [symbol] may be recorded in the suffix index, such as [symbol] .

The autocomplete query providing system 200 may update the query index database 203 by periodically repeating operations S302 and S303.

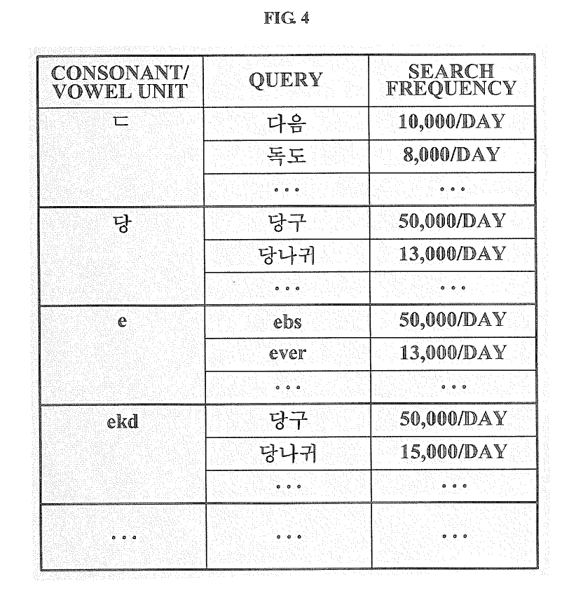

FIG. 4 is a diagram illustrating an example of the query index database 203 recording the query log which is divided using the consonant/vowel unit index according to an exemplary embodiment of the present invention.

As shown in FIG. 4, the query index database 203 may include each consonant/vowel unit, a query corresponding thereto, and a search frequency for each query, as the consonant/vowel unit index. As an example, [symbol] , [symbol] , etc. may be recorded as queries for the consonant/vowel unit [symbol] . Also, [symbol] , [symbol] , etc. may be recorded as queries for the consonant/vowel unit [symbol] . Also, ‘ebs’, ‘ever’, etc. may be recorded as queries for the consonant/vowel unit “e”, and [symbol] , [symbol] , etc. may be recorded as queries for the consonant/vowel unit “ekd”.

As shown in FIG. 4, each of the queries may be sorted in an order of a greater search frequency and recorded in the query index database 203. Also, each of the queries may be lexically sorted, and recorded in the query index database 203. In this case, the web server 204 may provide extracted autocomplete queries without performing a sorting process with respect thereto. Accordingly, a query autocompletion may be effectively performed in real time.

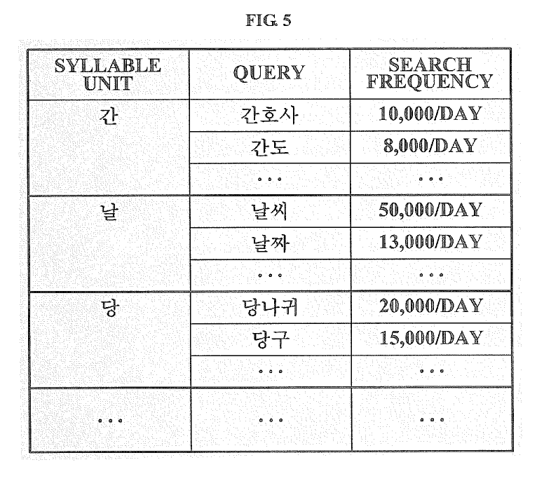

FIG. 5 is a diagram illustrating an example of the query index database 203 recording a query log which is divided using a syllable unit index according to an exemplary embodiment of the present invention.

As shown in FIG. 5, the query index database 203 may include each syllable unit, a query corresponding thereto, and a search frequency for each query, as the syllable unit index. As an example, [symbol] (a “nurse” in English), [symbol] (a name of an island in Korea peninsula), etc. may be recorded as queries for the syllable unit [symbol] , [symbol] (a “weather” in English), [symbol] (a “date” in English), etc. may be recorded as queries for the syllable unit [symbol] , and [symbol] , [symbol] , etc. may be recorded as queries for the syllable unit [symbol] . Also, as shown in FIG. 5, each of the queries may be sorted in an order of a greater search frequency and recorded in the query index database 203.

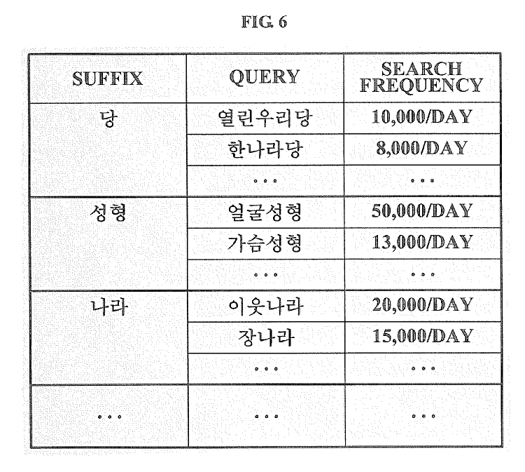

FIG. 6 is a diagram illustrating an example of the query index database 203 recording a query log which is divided using a suffix index according to an exemplary embodiment of the present invention.

As shown in FIG. 6, the query index database 203 may include each suffix, a query corresponding thereto, and a search frequency for each query, as the suffix index. As an example, [symbol] , [symbol] , etc. maybe recorded as queries for the suffix [symbol] . Also, [symbol] , [symbol] , etc. may be recorded as queries for the suffix [symbol] , and [symbol] , [symbol] , etc. may be recorded as queries for the suffix [symbol] . Also, as shown in FIG. 6, each of the queries may be sorted in an order of a greater search frequency and recorded in the query index database 203.

In operation S304, the web server 204 of the autocomplete query providing system 200 receives input information from the user's web browser 210, and transfers the received input information to the query autocompletion server 205. In this instance, the input information includes a partial or full search query entered by the user and a setting mode. Also, the setting mode includes selection information about at least one of the consonant/vowel unit index, the syllable unit index, and the suffix index.

In operation S305, the query autocompletion server 205 receives the partial or full search query from the web server 204, and determines whether the user input item is appropriate according to a predetermined standard. In operation S306, when the partial or full search query is inappropriate, the query autocompletion server 205 automatically converts the user input item into an appropriate query.

According to an embodiment of the present invention, there is provided a method of providing an autocomplete query in which the query autocompletion server 205 automatically converts the partial or full search query into an appropriate query consisting of a second character when the partial or full search query consists of a first character, and the first character and the second character are inputted via an identical character key of a predetermined character input device, and correspond to each other.

In this case, the second character may be Hangul when the first character is an alphabetical character, or the second character may be an alphabetical character when the first character is Hangul. As an example, when the partial or full search query is “ekdma”, the query autocompletion server 205 may determine that a keyboard is set to English and in this state, alphabetical characters were unintentionally inputted by the user into a search window, and convert “ekdma” into Hangul [symbol] corresponding to identical character keys of the keyboard. Contrary thereto, when the partial or full search query is [symbol] , the query autocompletion server 205 may determine that the keyboard is set to Hangul and this state, Hangul was unintentionally inputted by the user into the search window, and convert [symbol] into alphabetical characters, “cinema” corresponding to identical character keys of the keyboard.

Also, the query autocompletion server 250 may automatically convert the partial or full search query into an appropriate query automatically in real time as input of the partial or full search query progresses. As an example, when the user enters “e” into the search window, the query autocompletion server 205 converts “e” into Hangul [symbol] corresponding to an identical character key of the keyboard. Also, when the user additionally inputs “k”, and thus, the partial or full search query becomes “ek”, the query autocompletion server 205 converts “ek” into [symbol] . When the user additionally inputs “d”, and thus, the partial or full search query becomes “ekd”, the query autocompletion server 205 converts “ekd” into [symbol] . When the user additionally inputs “m”, and thus, the partial or full search query becomes “ekdm”, the query autocompletion server 205 converts “ekdm” into [symbol] . Also, when the user additionally inputs “a”, and thus, the partial or full search query becomes “ekdma”, the query autocompletion server 205 converts “ekdma” into [symbol] . Namely, through the process as described above, the query autocompletion server 205 may automatically convert the partial or full search query into the appropriate query substantially in real time as input of the partial or full search query progresses.

Also, according to another embodiment of the present invention, when the partial or full search query includes a mistyped character, the query autocompletion server 205 may automatically convert the partial or full search query into an appropriate query where the mistyped character is corrected. As an example, when the partial or full search query is [symbol] , the query autocompletion server 205 may determine that “o” is a mistyped character which is unintentionally inputted by the user, and convert the partial or full search query into the appropriate query, such as [symbol] .

In operation S305, the mode converter 206 of the autocomplete query providing system 200 determines whether the setting mode with respect to the partial or full search query is appropriate according to a predetermined standard. In operation S306, when the setting mode is inappropriate as a result of the determination, the mode converter 206 converts the setting mode into another mode.

As an example, when the received setting mode includes selection information about the syllable unit index, and in this state, a final syllable of the partial or full search query is a consonant, the mode converter 206 may convert the received setting mode into another setting mode which includes selection information about the consonant/vowel unit index.

As another example, when the received setting mode includes selection information about the consonant/vowel unit index, and in this state, the partial or full search query includes a borrowed character which can be divided into the consonant/vowel unit, the mode converter 206 may convert the received setting mode into another mode which includes selection information about the syllable unit index.

In operation S307, the query autocompletion server 205 of the autocomplete query providing system 200 extracts at least one suggested autocomplete query associated with the appropriate query from the index database 203.

Also, when extracting the at least one suggested autocomplete query in operation S307, the query autocompletion server 205 extracts the at least one suggested autocomplete query coresponding to the appropriate query from the query log corresponding to the selected index from the query index database 203, according to the setting mode included in the input information.

According to an embodiment of the present invention, in operation S307, when extracting the at least one suggested autocomplete query, the query autocompletion server 205 may extract a predetermined number of autocomplete queries in an order of a greater search frequency from the query log associated with the appropriate query.

As an example, although the user inputted “ek” into the search window and thus, the query autocompletion server 205 converted “ek,” into [symbol] , the query autocompletion server 205 may not extract all query logs starting with [symbol] , but extract the predetennined number of, for example, 10 autocomplete queries. Also, in this case, the query autocompletion server 205 may provide only highly possible queries that the user may input, by determining 10 autocomplete queries in an order of a greater search frequency.

When the mode converter 206 determines that the received setting mode is inappropriate, and automatically converts the received setting mode into another mode in operation S306, the query autocompletion server 205 may extract at least one suggested autocomplete query from the query log corresponding to the automatically converted mode from the query index database 203, in operation S307.

In operation S308, the web server 204 receives the at least one suggested auto complete query from the query autocompletion server 205, and transmits the received at least one suggested autocomplete query to the web browser 210. In this case, the web server 204 may transmit the at least one suggested autocomplete query and the received partial or full search query to the web browser 210.

In operation S309, the validity determination module 207 of the autocomplete query providing system 200 determines whether the partial or full search query received from the web server 204 is identical to a current input query. The current input query is inputted in the search window of the web browser 210 that the user is currently operating.

When the partial or full search query is determined to be identical to the current input query in operation S309, the validity determination module 207 extracts an autocomplete query list in operation S310. The autocomplete query includes the at least one suggested auto complete query received from the web server 204.

As described above, in operation S308, the web server 204 transmits the auto complete query list and the received partial or full search query to the web browser 210. The validity determination module 207 operating in the web browser 210 determines whether the converted partial or full search query is identical to the current input query of the web browser 210, and outputs the autocomplete query list.

Accordingly, the validity determination module 207 may prevent the auto complete query list, which is transmitted from the web server 204, from being generated when the user's current input query is delayed due to a network, through operations S309 and S3 10.

FIG. 7 is a diagram illustrating an example of an autocomplete query list which is provided to a user, when the user enters a query corresponding to a consonant/vowel unit according to an exemplary embodiment of the present invention.

As shown in FIG. 7, when the user enters “e” into the search window, a setting mode corresponding thereto is automatically determined as selection information about the consonant/vowel unit. The autocomplete query providing system 200 may perform operations S304 through S3 10, and output the autocomplete query list in a lower column of the search window. The autocomplete query list includes first autocomplete queries which are classified by the consonant/vowel unit index “e”, such as ‘e3’, ‘ebs’, ‘empas’, ‘ever’, ‘epson’, etc., and second auto complete queries which are classified by [symbol] , such as [symbol] , [symbol] , [symbol] , [symbol] , [symbol] , etc. Specifically, according to an embodiment of the present invention, when only “e” is inputted into the search window, the autocomplete query providing system 200 may output the first autocomplete queries which directly correspond to “e”, and the second auto complete queries corresponding to the automatically converted query [symbol] , as the auto complete query list.

Accordingly, the query autocompletion server 205 may extract a predetermined number of autocomplete queries which are arranged in an order of a greater search frequency for each query, and then transmit the extracted autocomplete queries to the web browser 210 via the web server 204. Unlike this, the query autocompletion server 205 may extract the predetermined number of autocomplete queries which are lexically arranged, and transmit the auto complete queries to the web browser 210 via the web server 204.

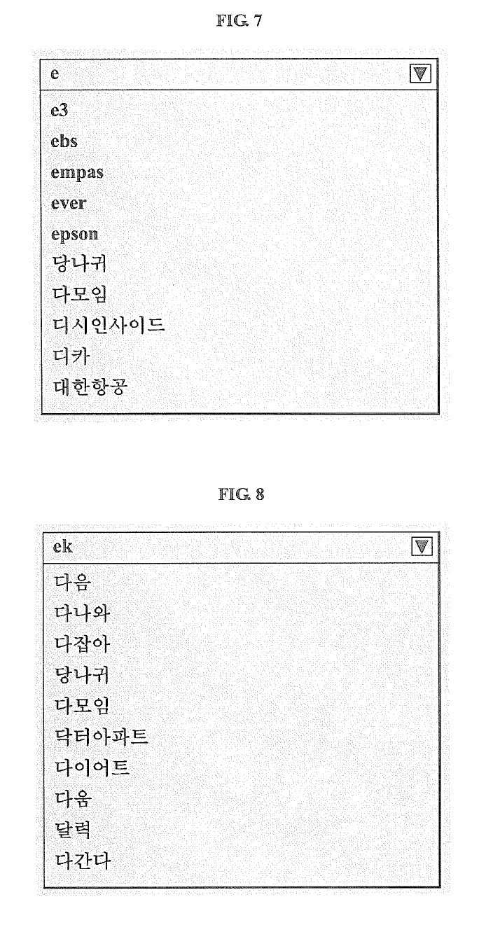

FIG. 8 is a diagram illustrating an example of an autocomplete query list which is provided to a user, when a consonant/vowel unit index is selected as a setting mode according to an exemplary embodiment of the present invention.

As shown in FIG. 8, when the user enters “ek” into the search window, the setting mode corresponding thereto may designate selection information about any one of the consonant/vowel unit index, the syllable unit index, and the suffix index. FIG. 8 illustrates an example of the auto complete query list which can be provided for the user when the consonant/vowel unit index is selected. Here, the setting mode may be selected by the user. Also, the setting mode may be arbitrarily selected by the autocomplete query providing system 200, not the user.

The autocomplete query providing system 200, which received “ek” as the partial or full search query and the “consonant/vowel unit index” as the setting mode, may perform operations S304 through S310, and thereby, convert “ek” into Hangul [symbol] corresponding to identical character keys, and output the autocomplete query list in a lower column of the search window.

The autocomplete query list includes queries which are classified by [symbol] , such as [symbol] , [symbol] , [symbol] , [symbol] , [symbol] , etc.

As described above, the query autocompletion server 205 may extract a predetermined number of autocomplete queries which are arranged in an order of a greater search frequency for each query, or lexically arranged, and then transmit the extracted autocomplete queries to the web browser 210 via the web server 204.

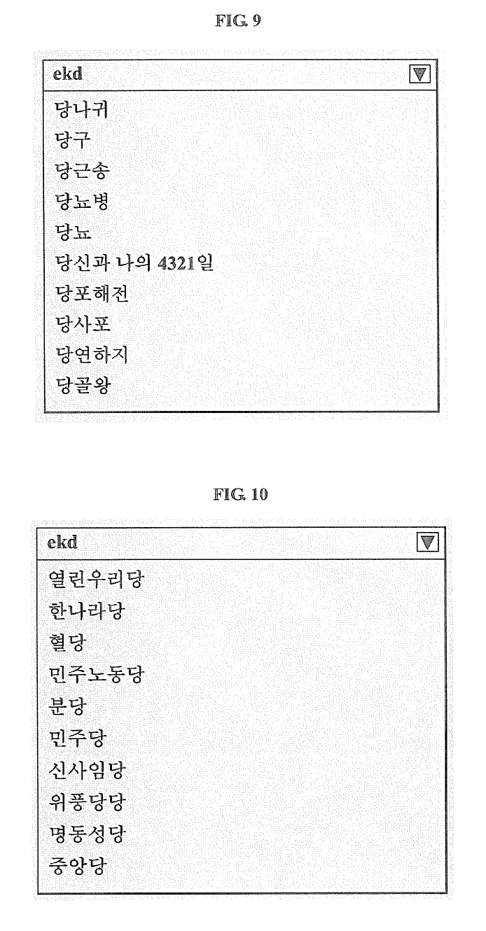

FIG. 9 is a diagram illustrating an example of an autocomplete query list which is provided to a user when a syllable unit index is selected as a setting mode according to an exemplary embodiment of the present invention.

FIG. 9 illustrates an example of the autocomplete query list which can be provided to the user when the user enters “ekd”, and the syllable unit index is selected as the setting mode. As described above, the setting mode may be selected by the user. Also, the setting mode may be arbitrarily selected by the autocomplete query providing system 200, not the user.

The autocomplete query providing system 200, which received “ekd” as the partial or fall search query and the “syllable unit index” as the setting mode, may perfonn operations S304 through S310, and thereby, convert “ekd” into Hangul [symbol] corresponding to identical character keys, and output the autocomplete query list in a lower column of the search window. The auto complete query list includes queries which are classified by [symbol] , such as [symbol] , [symbol] , [symbol] , etc.

Even in this case, the query autocompletion server 205 may extract a predetermined number of autocomplete queries which are arranged in an order of a greater search frequency for each query, or lexically arranged, and then transmit the extracted autocomplete queries to the web browser 210 via the web server 204.

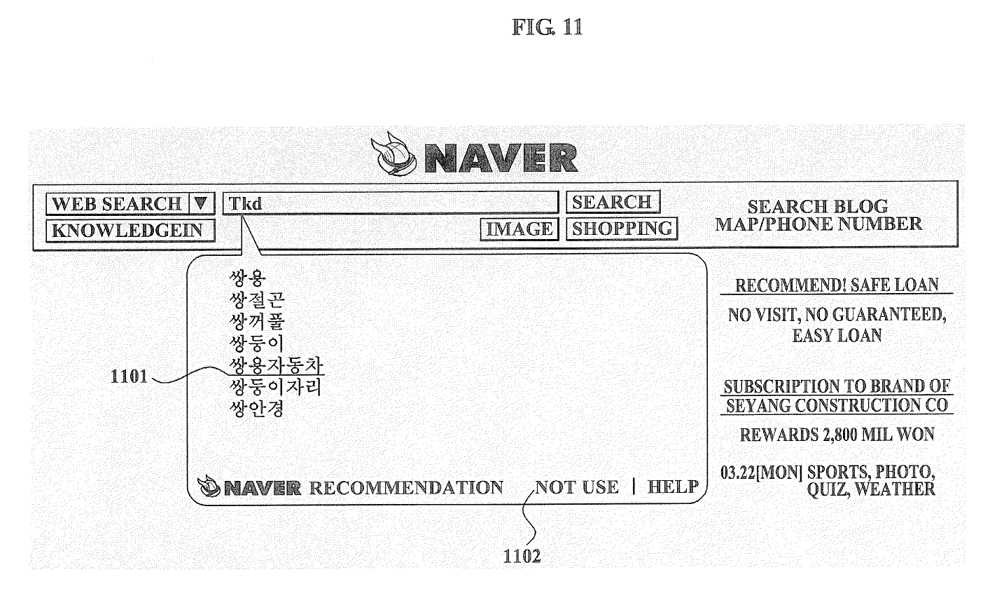

FIG. 10 is a diagram illustrating an example of an autocomplete query list which is provided to a user when a suffix index is selected as a setting mode according to an exemplary embodiment of the present invention.

FIG. 10 illustrates an example of the autocomplete query list which can be provided to the user, when the user enters “ekd”, and the suffix index is selected as the setting mode. As described above, the setting mode may be selected by the user. Also, the setting mode may be arbitrarily selected by the autocomplete query providing system 200, not the user.

The autocomplete query providing system 200, which received “ekd” as the partial or full search query and the “suffix index” as the setting mode, may perform operations S304 through S310, and thereby, convert “ekd” into Hangul [symbol] corresponding to identical character keys, and output the autocomplete query list in a lower column of the search window. The auto complete query list includes queries which are classified by [symbol] , such a [symbol] , [symbol] , [symbol] , [symbol] , etc.

Even in this case, the query autocompletion server 205 may extract a predetermined number of autocomplete queries which are arranged in an order of a greater search frequency for each query, or lexically arranged, and then transmit the extracted autocomplete queries to the web browser 210 via the web server 204.

FIG. 11 is a diagram illustrating an autocomplete query list which is overlapped on a search webpage according to an exemplary embodiment of the present invention.

As shown in FIG. 11, the autocomplete query providing system 200 provides a user with the autocomplete query list substantially in real time in correspondence to the user's inputting the partial or full search query into a search window of the search webpage. As shown in FIG. 11, when the user enters “Tkd”, the autocomplete query providing system 200 may convert “Tkd” into [symbol] , extract the autocomplete query list which is classified by [symbol] , and provide the user with the extracted autocomplete query list.

In this case, as shown in FIG. 11, the autocomplete query list may be overlapped on the search webpage, and outputted to the user. The user may select the user's desired query from the outputted autocomplete query list, by using a mouse, an arrow key on a keyboard, etc. In this case, a search using the selected query may be immediately performed.

Also, according to an embodiment of the present invention, the autocomplete query providing system 200 may provide the user with the autocomplete query list where an auto complete query satisfying a predetermined condition is distinguished from other auto complete queries.

As an example, in the case of an autocomplete query which is identical to the user's current input query in the search window, or in the case of an autocomplete query which can provide a tailored service using an associated content search or a shortcut link, the auto complete query providing system 200 may distinctively indicate the autocomplete query using a color, an underline, a bold, a font, etc., or may provide the user with the autocomplete query with an icon.

Referring to FIG. 11, it can be seen that [symbol] 1101 is distinctive from other auto complete queries in the autocomplete query list, using a color, an underline, and italics. In this case, the user may recognize that a content search or a shortcut link associated with the query [symbol] exists, select the content search or the shortcut link, and receive tailored search results associated with the query.

When the user does not wish to be provided with the autocomplete query list while inputting a query in the webpage, the user may select a “not use” item 1102, so as to not output the autocomplete query list. In this case, the autocomplete query providing system 200 stops operations S304 through S310.

Also, when the user desires to be provided with the autocomplete query list again, the user may activate a corresponding function via an option button in the search window. In this case, the autocomplete query providing system 200 may re-perform operations S304 through S310, and output the autocomplete query list.

The autocomplete query providing method according to the above-described embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perfonn program instructions, such as read-only memory (ROM), random access memory (RAM), flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, there is provided a method and system for providing an autocomplete query, which can provide a user with an appropriate query in real time when the user enters a query.

Also, according to the present invention, there is provided a method and system for providing an autocomplete query, which can provide a new type of search service capability of preventing a user from inputting a mistyped character and having capability to educate the user on how to create an appropriate query.

Also, according to the present invention, there is provided a method and system for providing an autocomplete query, which can convert a query into an appropriate query and provide a user with an autocomplete query corresponding to the appropriate query in real time, even when the user enters an unintentional query because of a mis-configured keyboard, such as when a keyboard is set to English, but the user enters the query according to a Hangul keyboard, and when a keyboard is set to Hangul, but the user enters the query according to an English keyboard.

Also, according to the present invention, there is provided a method and system for providing an autocomplete query, which enables a user to select a desired query from the auto complete query list while the user is inputting a query, and thereby, easily complete the query by providing the user with an autocomplete query list where a query log is classified for each index and the query that the user is currently inputting can be automatically completed according to partial or full search query entered by the user and a setting mode which are received from the user's web browser.

Also, according to the present invention, there is provided a method and system for providing an autocomplete query, which can classify a query log according to a consonant/vowel unit to be appropriate for a particular language, which can be classified into a consonant/vowel unit, such as Hangul, and can extract an autocomplete query corresponding to the classified query log, and provide a user with the extracted autocomplete query, when the user enters a query corresponding to the consonant unit/vowel unit.

Also, according to the present invention, there is provided a method and system for providing an autocomplete query, which can provide a query autocompletion capability using both a prefix and a suffix. Here, the prefix is added to the beginning of a word and the suffix is added to the end of the word.

Also, according to the present invention, there is provided a method and system for providing an autocomplete query, which can significantly reduce temporal and economic losses in preparing a converting list or a recommendation list for correcting a mistyped character by constructing a system that can effectively classify a query log received from a user for each index according to various standards, extract an autocomplete query with respect to partial or full search query entered by the user in real time, and provide the extracted autocomplete query.

Also, according to the present invention, there is provided a method and system for providing an autocomplete query, which can embody a query autocompletion to thereby reduce a user's query input time, and assist the user, particularly, the user who is poor at using a keyboard, when inputting a query.

Also, according to the present invention, there is provided a method and system for providing an autocomplete query, which can supplement a user's memory when the user remembers only a part of a query.

Also, according to the present invention, there is provided a method and system for providing an autocomplete query, which can satisfy a user who desires to understand other users' query tendencies with respect to a corresponding input query.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A search query processing system, the system comprising:
a log database for maintaining a query log;
a log indexer module for classifying the query log maintained in the log database;
a query index database for dividing and storing the classified query log;
a web server for receiving a partial or full search query entered by a user from a user's web browser, the web server transferring the received partial or full search query to a predetermined query autocompletion server, the web server receiving at least one suggested auto complete query from the query autocompletion server, and the web server transmitting the received at least one suggested autocomplete query to the web browser; and
the query autocompletion server for receiving the partial or full search query from the web server, the query autocompletion server determining whether the partial or full search query is appropriate according to a predetermined standard, and when the partial or full search query is inappropriate to the predetermined standard, the query autocompletion server automatically converting the partial or full search query into an appropriate query, the query autocompletion server extracting at least one suggested autocomplete query associated with the appropriate query from the query index database, and the query autocompletion server transmitting the extracted at least one suggested autocomplete query to the web server.

2. The system of claim 1, wherein the log indexer module classifies the query log according to any one of a consonant/vowel unit, a syllable unit, and a suffix, and
the query index database divides and records the classified query for each of the any one of consonant/vowel unit indexes, syllable unit indexes, and suffix indexes.

3. The system of claim 2, wherein the web server further receives a setting mode from the web browser, and transfers the received setting mode to the query autocompletion server, the setting mode comprising selection information about at least one of the consonant/vowel unit index, the syllable unit index, and the suffix index, and
the query autocompletion server extracts at least one suggested autocomplete query from the query log corresponding to the selected index from the query index database.

4. The system of claim 3, wherein the query autocompletion server automatically converts the partial or full search query into an appropriate query comprising a second character, when the partial or full search query comprises a first character, and
the first character and the second character are inputted via an identical character key of a predetermined character input device.

5. The system of claim 4, wherein the second character is Hangul when the first character is an alphabetical character, or the second character is an alphabetical character when the first character is Hangul.

6. The system of claim 1, wherein the query autocompletion server automatically converts the partial or full search query into an appropriate query where a mistyped character is corrected, when the partial or full search query comprises the mistyped character.

7. The system of claim 1, wherein the query autocompletion server automatically converts the partial or full search query into an appropriate query substantially in real time as the user is entering the partial or full search query, and extracts the autocomplete query.

8. The system of claim 3, wherein the query autocompletion server comprises:
a mode converter for determining whether the setting mode with respect to the partial or full search query is appropriate according to a predetermined standard, and when the setting mode is inappropriate, automatically converting the setting mode into another mode.

9. A method of providing an autocomplete query, the method comprising:
maintaining a query log in a log database;
classifying the query log maintained in the log database in a log indexer module;
storing the classified query log in a query index database;
receiving a partial or full search query entered by a user from a user's web browser and transferring the received partial or full search query to a predetermined query autocompletion server, using a web server;
receiving the partial or full search query from the web server, determining whether the partial or full search query is appropriate according to a predetermined standard, and when the partial or full search query is inappropriate according to the predetennined standard, automatically converting the partial or full search query into an appropriate query, extracting at least one suggested autocomplete query associated with the appropriate query from the query index database, and transmitting the extracted at least one suggested autocomplete query to the web server, using the query autocompletion server; and
receiving at least one suggested autocomplete query from the query autocompletion server and transmitting the received at least one suggested autocomplete query to the web browser, using the web server.

10. The method of claim 9, wherein the classifying of the maintained query log comprises:
classifying the query log according to any one of a consonant/vowel unit, a syllable unit, and a suffix, and
classifying and storing the classified query log for each of the any one of consonant/vowel unit indexes, syllable unit indexes, and suffix indexes.

11. The method of claim 9, wherein, in the receiving and the transferring, the web server receives a setting mode from the web browser, and transfers the received setting mode to the query autocompletion server, the setting mode comprising selection information about at least one of the consonant/vowel unit index, the syllable unit index, and the suffix index, and, in the extracting of the autocomplete query, the query autocompletion server extracts at least one suggested autocomplete query from the query log corresponding to the selected index from the query index database.

12. The method of claim 9, wherein, in the converting, the query autocompletion server automatically converts the partial or full search query into an appropriate query comprising a second character when the partial or full search query comprises a first character, and the first character and the second character are inputted via an identical character key of a predetermined character input device, and correspond to each other.

13. The method of claim 12, wherein the second character is Hangul when the first character is an alphabetical character, or the second character is an alphabetical character when the first character is Hangul.

14. The method of claim 9, wherein, in the converting, the query autocompletion server automatically converts the partial or full search query into an appropriate query where a mistyped character is corrected, when the partial or full search query comprises the mistyped character.

15. The method of claim 9, wherein, in the converting and the extracting, the query autocompletion server automatically converts the partial or full search query into an appropriate query substantially in real time as the user is entering the partial or full search query, and extracts the autocomplete query.

16. A computer-readable record medium storing a program for implementing a method of providing an autocomplete query, the method comprising:
maintaining a query log in a log database;
classifying the query log maintained in the log database;
storing the classified query log in a query index database;
receiving a partial or full search query entered by a user from a user's web browser and transferring the received partial or full search query to a predetermined query autocompletion server, using a web server;
receiving the partial or full search query from the web server, determining whether the partial or full search query satisfies a predetermined standard, and when the partial or full search query does not satisfies the standard, automatically converting the partial or full search query into an appropriate query, extracting at least one suggested autocomplete query associated with the appropriate query from the query index database, and transmitting the extracted at least one suggested autocomplete query to the web server, using the query autocompletion server; and
receiving at least one suggested autocomplete query from the query autocompletion server and transmitting the received at least one suggested autocomplete query to the web browser, using the web server.
